(19) United States
(12) Patent Application Publication
(10) Pub. No.: US 2007/0001932 A1
(43) Pub. Date: Jan. 4, 2007

(54) Plasma display device and method of treating the same

(75) Inventors: Yoshinori Miyazaki, Yokohama (JP); Yasuji Noguchi, Yokohama (JP); Masaya Tajima, Higashimurayama (JP); Ayahito Kojima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Miyazaki (JP)

(21) Appl. No.: 11/453,289

(22) Filed: Jun. 15, 2006

(30) Foreign Application Priority Data
Jun. 17, 2005 (JP) 2005-178219
Apr. 26, 2006 (JP) 2006-122403

(51) Int. Cl. G09G 3/28

(52) U.S. Cl. 345/60

(57) ABSTRACT

Aiming at more exactly correcting luminance degradation in a color-wise manner, a plasma display device proposed herein has a gain correction section color-wisely correcting gains of video signals for a plurality of colors; and a plasma display panel presenting display corresponding to the gain-corrected video signals while being supplied with sustain pulses, wherein the gain correction section color-wisely corrects gains of the video signals, corresponding to time corresponded to the operation time, video load ratio, and the number of the sustain pulses or values relevant thereto.

### CROSS-REFERENCE TO RELATED APPLICATIONS

This application is based upon and claims the benefit of priority from the prior Japanese Patent Application Nos. 2005-178219, filed on Jun. 17, 2005 and 2006-122403, filed on Apr. 26, 2006, the entire contents of which are incorporated herein by reference.

### BACKGROUND OF THE INVENTION

1. Field of the Invention

The present invention relates to a plasma display device and a method of treating the same.

2. Description of the Related Art

Plasma display devices suffer from degradation of individual phosphors for red, green and blue colors. Difference in degrees of degradation from color to color has been causative of changes in the white balance, and has resulted in degradation of image quality. Patent Document 1 listed below discloses a plasma display device configured as correcting gains of the individual amplifiers for RGB corresponding to cumulative values of operation time. Patent Document 2 listed below discloses a display device configured as correcting difference in luminance levels among the individual cells estimated based on cumulative values of the number of applied effective-pulses for discharge for the individual cells, so as to allow application of the effective pulses for discharge.

Related arts are disclosed in:

[Patent Document 1] Japanese Patent Application Laid-Open No. 2004-61863; and

[Patent Document 2] Japanese Patent Application Laid-Open No. 2004-240101.

The gain correction solely based on the cumulative values of operation time, however, cannot reflect difference in load-induced degradation of video luminance, and fails in exactly estimating the luminance degradation characteristics. Problems also reside in that accumulation of the number of application of the effective pulses for discharge for the individual cells may increase the cost due to expansion of circuit configuration and addition of a memory device, and reside in difficulty of ensuring storage time in the memory device. Still another problem resides in that changes in lifetime characteristics ascribable to difference in the effective pulse voltage for discharge are not reflected, so that the luminance degradation characteristics cannot be estimated in a more exact manner.

### SUMMARY OF THE INVENTION

It is an object of the present invention to provide a plasma display device capable of exactly correcting luminance degradation in a color-wise manner, and a method of treatment therefor.

A plasma display device of the present invention has a gain correction section color-wisely correcting gains of video signals for a plurality of colors; and a plasma display panel presenting display corresponding to the gain-corrected video signals while being supplied with sustain pulses. The gain correction section color-wisely corrects gains of the video signals, corresponding to time corresponded to the operation time, video load ratio, and the number of the sustain pulses or values relevant thereto.

In another aspect, a plasma display device of the present invention has a gain correction section color-wisely correcting gains of video signals for a plurality of colors; and a plasma display panel presenting display based on electric discharge, corresponding to the gain-corrected video signals while being supplied with sustain pulses. The gain correction section color-wisely corrects gains of the video signals, corresponding to time corresponded to the operation time, video load ratio, and power of the electric discharge.

A method of treating a plasma display device of the present invention is such as treating a plasma display device which includes a gain correction section color-wisely correcting gains of video signals for a plurality of colors; and a plasma display panel presenting display corresponding to the gain-corrected video signals while being supplied with sustain pulses, wherein the method includes a gain correction step color-wisely correcting gains of the video signals, corresponding to the time corresponded to the operation time, video load ratio, and the number of the sustain pulses or values relevant thereto; and a display step presenting display corresponding to the gain-corrected video signals.

A method of treating a plasma display device is also such as treating a plasma display device which includes a gain correction section color-wisely correcting gains of video signals for a plurality of colors; and a plasma display panel presenting display based on electric discharge, corresponding to the gain-corrected video signals while being supplied with sustain pulses, wherein the method includes a gain correction step color-wisely correcting gains of the video signals, corresponding to time corresponded to the operation time, video load ratio, and power of the electric discharge; and a display step presenting display, corresponding to the gain-corrected video signals.

### BRIEF DESCRIPTION OF THE DRAWINGS

FIG. 1 is a drawing showing an exemplary configuration of the plasma display device according to an embodiment of the present invention;

FIGS. 2A to 2C are drawings showing exemplary sectional configurations of the cell;

FIG. 3 is a drawing showing an exemplary configuration of a drive circuit of the plasma display device shown in FIG. 1;

FIG. 4 is a drawing showing an exemplary configuration of one frame of image;

FIG. 5 is a waveform chart showing an example of basic operation of the plasma display device shown in FIG. 1;

FIG. 6 is a drawing showing an exemplary configuration of the gain correction section of the plasma display device shown in FIG. 1;

FIG. 7 is a drawing showing an exemplary configuration of the gain correction section shown in FIG. 6;

FIG. 8 is a graph showing exemplary relationships between time and rates of luminance degradation;

FIG. 9 is a graph showing an exemplary relationship between the video load ratio and sustain discharge power;

FIG. 10 is a graph showing an exemplary relationship between Ns (the number of sustain pulses)×K1 (video load ratio) and K1 (video load ratio);

FIG. 11 is a graph showing exemplary relationships between video load ratio and the number of sustain pulses, under varied sustain pulse voltage values;

FIG. 12 is a graph showing exemplary relationships between time and the rate of luminance degradation, under varied sustain pulse voltage values;

FIG. 13 is a drawing showing an exemplary configuration of a circuit generating gain correction coefficients based on luminance degradation coefficients and chromaticity change coefficients;

FIG. 14 is a chart of chromaticity;

FIG. 15 is a graph showing exemplary relationships between time and x value of chromaticity;

FIG. 16 is a graph showing exemplary relationships between time and y value of chromaticity;

FIG. 17 is a drawing showing an exemplary configuration of a circuit generating gain correction coefficients based on luminance degradation coefficients, chromaticity change coefficients and front filter characteristics;

FIG. 18 is a drawing showing an exemplary configuration shown by the sectional drawing in FIG. 2A added with a front filter;

FIG. 19 is a graph showing an exemplary characteristic of the front filter; and

FIG. 20 is a graph showing an exemplary emission intensity of the plasma display panel.

### DETAILED DESCRIPTION OF THE PREFERRED EMBODIMENTS

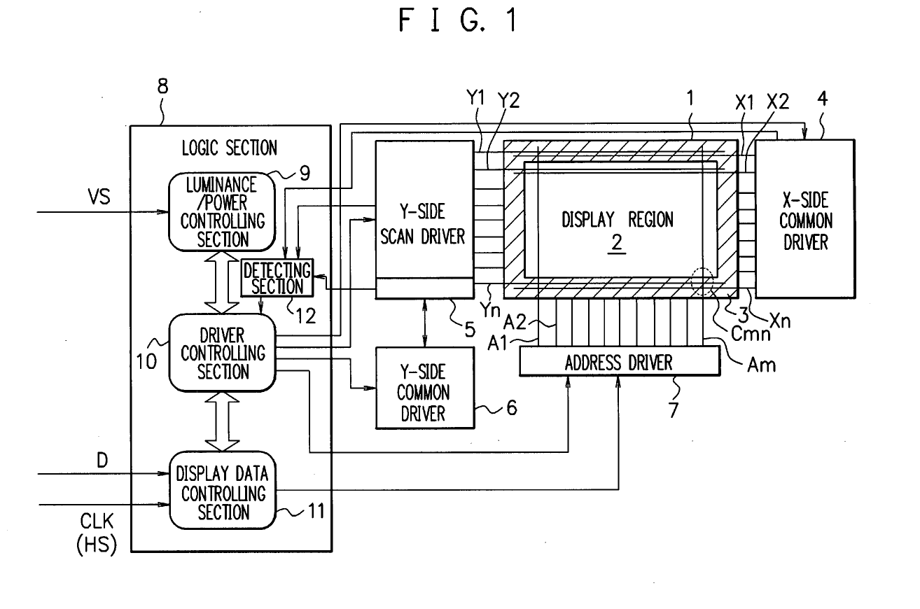

FIG. 1 is a drawing showing and exemplary configuration of the plasma display device according to an embodiment of the present invention. The plasma display device of this embodiment has scanning electrodes (display electrodes) Y1 to Yn and display electrodes X1 to Xn parallel to each other, and address electrode A1 to Aj provided normal to (so as to cross) these electrodes Y1 to Yn, and X1 to Xn. The display electrodes X1 to Xn are provided as being corresponded to, and in the vicinity of the scanning electrode Y1 to Yn, respectively.

The display panel 1 has a plurality of cells arranged in a form of a matrix of m rows and n columns. Each cell Cij is composed of an intersection of a scanning electrode Y1 and an address electrode Aj, and an adjacent display electrodes Xi corresponded thereto. The cell Cij corresponds to one pixel of a displayed image, and thereby the display panel 1 can present a two-dimensional image.

The display panel 1 has a display region 2 and a non-display region 3 (referred to as “dummy display region”, hereinafter) provided therearound. The display region 2 is a region presenting an image to be displayed based on input video signals (input data) D, wherein in the cells in the region 2, the individual electrodes X, Y and A are driven corresponding to the input video signal D. On the other hand, the dummy display region 3 is a region always shown in black irrespective of the input video signal D, wherein in the cells in the region 3, the individual electrodes X, Y and A are driven always as being corresponded to the black-level display.

The display electrodes X1 to Xn are connected to the output end of an X-side common driver 4 supplying a predetermined voltage (drive pulse) to the display electrodes X1 to X, under control by a driver controlling section 10. The scanning electrodes Y1 to Yn are connected to the output end of a Y-side scan driver 5 supplying a predetermined voltage (drive pulse) to the scanning electrodes Y1 to Yn, under control by the driver controlling section 10 and a Y-side common driver 6. The address electrodes A1 to Aj are connected to the output end of an address driver 7 applying a predetermined voltage (drive pulse) to the address electrodes A1 to Aj, under control of a display data controlling section 11 and the driver controlling section 10.

The X-side common driver 4 is composed of a circuit repeating discharge, and the address driver 7 is composed of a circuit selecting rows to be displayed. The Y-side scan driver 5 and the Y-side common driver 6 compose a Y-side circuit, and the Y-side circuit is composed of a circuit taking part in line-sequential scanning and a circuit repeating the discharge. Display operation of the plasma display device is effected by determining which cells to be illuminated with the aid of the circuit taking part in the line-sequential scanning in the Y-side circuit and the address driver 7, and by repeating the discharge with the aid of the X-side common driver 4 and the circuit repeating the discharge in the Y-side circuit.

A logic section 8 has a luminance/power controlling section 9, the driver controlling section 10, the display data controlling section 11, and a detecting section 12. The logic section 8 generates a control signal based on the externally-supplied input video signal D, a dot clock CLK indicating read timing of the input video signal D, a horizontal synchronizing signal HS and a vertical synchronizing signal VS, and supplies it to the X-side common driver 4, the Y-side scan driver 5, the Y-side common driver 6, and the address driver 7.

More specifically, in the logic section 8, the driver controlling section 10 generates a control signal based on signals supplied from the luminance/power controlling section 9 and the display data controlling section 11, and outputs it. In this process, the driver controlling section 10 generates the control signal so as to appropriately modify the drive pulse applied by the drivers 4 to 7 to the individual electrodes X, Y and A, corresponding to the individual data supplied from the detecting section 12.

The data supplied herein from the detecting section 12 to the driver controlling section 10 include operation time of the plasma display device, discharge power (current) under which the display electrodes X1 to Xn and the scanning electrode Y1 to Yn of the display panel 1 are applied with the sustain pulses, and data indicating sustain pulse voltage. In other words, the detecting section 12 detects the above-described operation time, the discharge power value and the sustain pulse voltage, and supplies the data based on the detection results to the driver controlling section 10. The above-described operation time is a cumulative time (power supply time) during which the power was supplied to the plasma display device. The above-described discharge power is obtained by detecting current flowing through the display electrodes X1 to Xn and the scanning electrode Y1 to Yn in the display panel 1.

The display data controlling section 11 detects a video load ratio corresponding to the input video signal D, and outputs it to the driver controlling section 10. The video load ratio is detected based on the number of illuminant pixels and gradation values for the illuminant pixels. For an exemplary case where all pixels are displayed with a maximum gradation value, the video load ratio will have a value of 100%. For another exemplary case where all pixels are displayed with a half of the maximum gradation value, the video load ratio will have a value of 50%. For still another exemplary case where only a half (50%) of the pixels are displayed with the maximum gradation value, the video load ratio again will have a value of 50%.

The luminance/power controlling section 9 receives an input of the above-described discharge power or the video load ratio from the driver controlling section 10, determines based thereon the number of sustain pulses to be applied to the display electrodes X1 to Xn and the scanning electrode Y1 to Yn so as to make the power constant, and outputs the number to the driver controlling section 10. The driver controlling section 10 controls the drivers 4 and 5 so as to apply thus determined number of sustain pulses to the display electrodes X1 to Xn and the scanning electrodes Y1 to Yn.

The input video signal D is a digital signal supplied, in a parallel manner, through signal lines for red, green and blue colors. The display data controlling section 11 color-wisely corrects gains of the input video signal D. This process makes it possible to color-wisely correct luminance degradation, to maintain a desirable white balance, and to prevent the image quality from degrading. The driver controlling section 10 calculates a luminance degradation characteristic time (luminance degradation characteristic data) based on the above-descried operation time, the video load ratio, the number of sustain pulses, the discharge power, and/or the sustain pulse voltage, and controls the amount of correction of the display data controlling section 11 for the individual colors. The details will be given later.

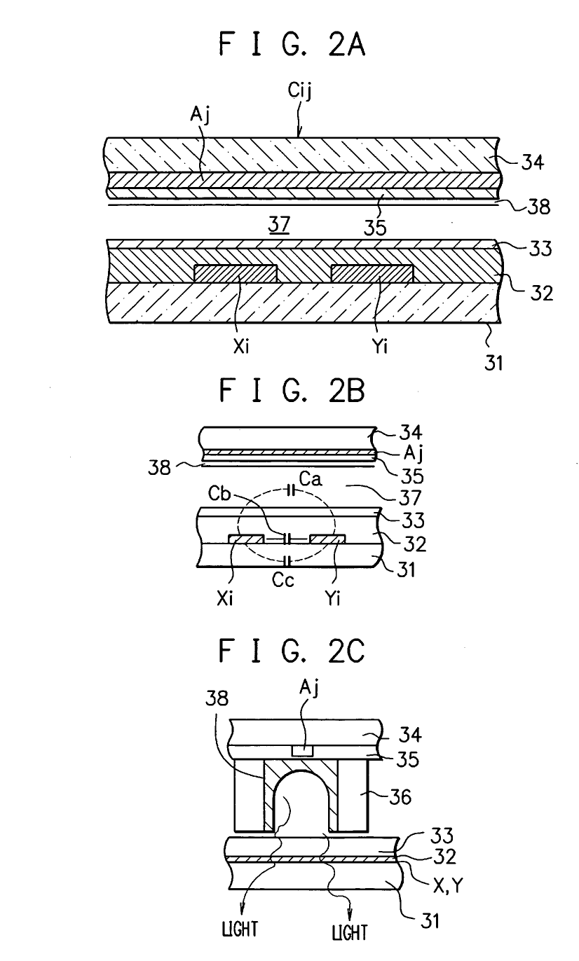

FIG. 2A is a drawing showing an exemplary sectional configurations of a cell Cij as a single pixel on the i-th row and the j-th column. In FIG. 2A, the display electrodes Xi and the scanning electrode Yi are formed on a front glass substrate 31. A dielectric layer 32 ensuring isolation from a discharge space 37 is deposited thereon, and a MgO (magnesium oxide) protecting film 33 is deposited further thereon.

On the other hand, the address electrode Aj is formed on a back glass substrate 34 disposed as being opposed with the front glass substrate 31, a dielectric layer 35 is deposited thereon, and a fluorescent material 38 is deposited further thereon. The discharge space 37 between the MgO protecting film 33 and the dielectric layer 35 has a Ne+Xe Penning gas or the like encapsulated therein.

FIG. 2B is a drawing explaining capacitance Cp of the plasma display. As shown in FIG. 2B, each cell of the plasma display has capacitive components Ca, Cb and Cc in the discharge space 37, between the display electrodes Xi and the scanning electrode Yi, and in the front glass substrate 31, respectively, wherein the total of them determines capacitance Cp_{cell} of the single cell (Cp_{cell}=Ca+Cb+Cc). Total of capacitance Cp_{cell} of all cells the gives panel capacitance Cp.

FIG. 2C is a drawing explaining light emission of the plasma display. As shown in FIG. 2C, the phosphors 38 of red, blue and green are coated and arranged with a stripe pattern color-by-color, on the inner surface of ribs 36, so as to excite the phosphors 38 to emit light by discharge between the display electrode Xi and the scanning electrode Yi.

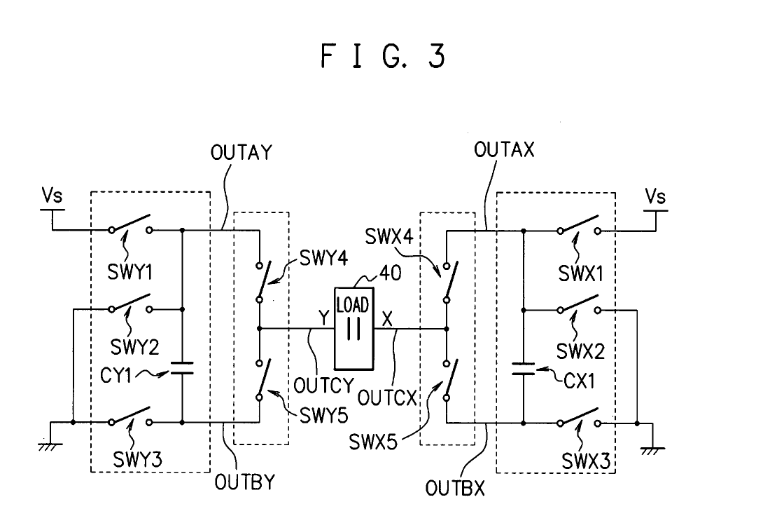

FIG. 3 is a drawing showing an exemplary configuration of a drive circuit of the plasma display device shown in FIG. 1. The drive circuit shown in FIG. 3 corresponds to the X-side common driver 4, the Y-side scan driver 5, and the Y-side common driver 6 in FIG. 1.

In FIG. 3, capacitive load (simply referred to as “load”, hereinafter) 40 is a total capacitance of the cells each formed between any arbitrary one display electrode X of the above-described plurality of display electrodes X1 to Xn and any arbitrary one scanning electrode Y of the plurality of scanning electrodes Y1 to Yn. The load 40 has a common electrode X and a scanning electrode Y formed thereon.

The Y-side circuit driving the scanning electrode Y has one capacitor CY1 and five switches SWY1 to SWY5.

The switches SWY1, SWY2 are connected in series between a power source line (source line) at voltage Vs supplied from a power source and the ground (GND) as the reference potential. A mutual connection point between the two switches SWY1, SWY2 is connected with one terminal of the capacitor CY1, and the switch SWY3 is connected between the other terminal of the capacitor CY1 and the ground. A signal line connected to one terminal of the capacitor CY1 is defined as a first signal line OUTAY, and a signal line connected to the other terminal is defined as a second signal line OUTBY.

The switches SWY4, SWY5 are connected in series between both ends of the capacitor CY1 in a power source circuit 22. More specifically, the switches SWY4, SWY5 are connected in series between the first and second signal lines OUTAY, OUTBY. An interconnection point between two switches SWY4, SWY5 is connected via an output line OUTCY to the scanning electrode Y of the load 40.

The X-side circuit driving the common electrode X is configured similarly to the above-described Y-side circuit, so that repetitive explanation will be omitted.

When the switches SWY1, SWY3 and SWY4 are turned on and the switches SWY2, SWY5 are turned off on the Y-side of the drive circuit shown in FIG. 3, the capacitor CY1 is accumulated with electric charge corresponded to voltage Vs applied by the switches SWY1, SWY3, and voltage Vs on the first signal line OUTAY is applied via the output line OUTCY to the load 40.

When the switches SWY2, SWY5 are turned on and the switches SWY1, SWY3, SWY4 are turned off while keeping electric charge corresponded to voltage Vs accumulated in the capacitor CY1, voltage on the second signal line OUTBY is brought down to (−Vs), and the voltage (−Vs) is applied via the output line OUTCY to the load 40.

As described in the above, the positive voltage Vs and the negative voltage (−Vs) are alternatively applied to the scanning electrode Y of the load 40. Similarly, the positive voltage Vs and the negative voltage (−Vs) are alternatively applied also to the common electrode X of the load 40, by a similar switching control. In this process, the voltages (±Vs) applied to the scanning electrode Y and the common electrode X are adjusted to have phases inverted from each other. More specifically, if the scanning electrode Y is applied with the positive voltage Vs, the common electrode X is applied with the negative voltage (−Vs). It is therefore made possible to generate potential difference capable of causing discharge between the scanning electrode Y and the common electrode X.

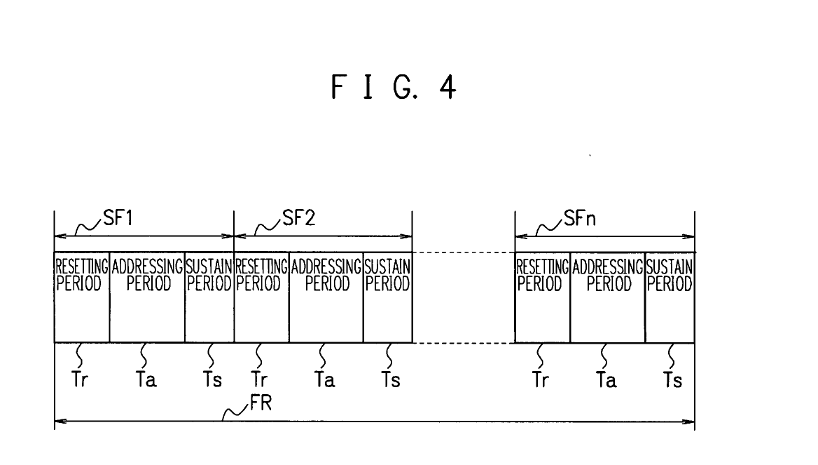

FIG. 4 is a drawing showing an exemplary configuration of one frame FR of an image. The image is formed typically at a rate of 60 frames/second. One frame FR is composed of a first subframe SF1, a second subframe SF2, . . . , and an n-th subframe SFn. The n is typically has a value of 10, and corresponds with the number of gradation bit. The subframes SF1, SF2 and so forth are individually or generally referred to as “subframe SF”, hereinafter.

Each subframe SF has a resetting period Tr, an addressing period Ta, and a sustain period (sustain discharge period) Ts. In the resetting period Tr, the display cells are initialized. In the addressing period Ta, illumination and non-illumination of the individual display cells are selectable by specifying address. Selected cells emit light in the sustain period Ts. The number of times (duration) of light emission differ in the individual fields. Gradation value can therefore be determined.

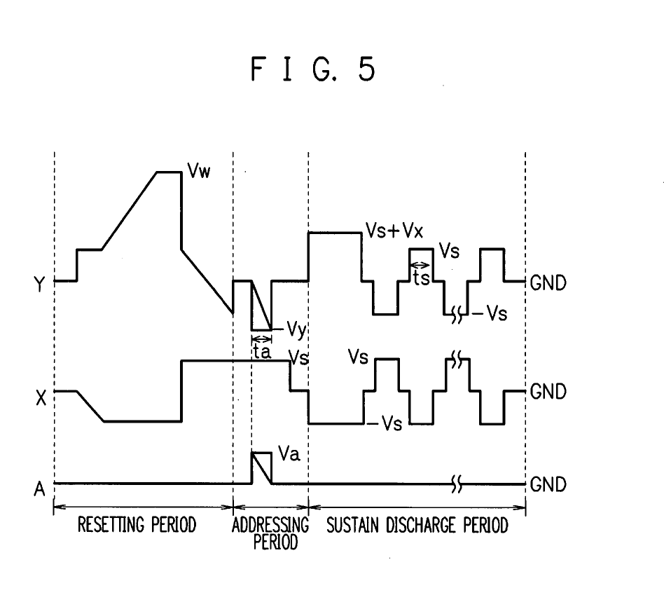

FIG. 5 is a waveform chart showing an example of basic operation of the plasma display device shown in FIG. 1. FIG. 5 shows examples of drive pulses (voltage) applied to the common electrode X, the scanning electrode Y, and the address electrode A in one subfield. As described in the above, one subfield is divided into the resetting period composed of a full-writing period and full-erasure period, the addressing period, and the sustain discharge period.

In the resetting period, voltage to be applied to the common electrode X is first brought from the ground level as the reference potential down to (−Vs). On the other hand, voltage to be applied to the scanning electrode Y gradually rises with time, and the write voltage Vw is finally applied to the scanning electrode Y.

The common electrode X and the scanning electrode Y thus applied with the resetting pulses produce potential difference (Vs+Vw) therebetween, and electric discharge takes place in all cells in all display lines, irrespective of the former state of display, to thereby form the wall charge (full writing).

Next, voltage values of the common electrode X and the scanning electrode Y are returned back to the ground level, and voltage applied to the common electrode X is raised from the ground level up to Vs, and voltage applied to the scanning electrode Y is brought down to (−Vs). The wall charge in all cells then exceeds the discharge initiation voltage, thereby the electric discharge is triggered, and the accumulated wall charge is erased (full erasure).

Next in the addressing period, line-sequential addressing discharge takes place in order to turn on/off the individual cells corresponding to the input video signal. The common electrode X at this time is applied with voltage Vs. For the case where the scanning electrode Y corresponded to a certain display line is applied with voltage, a (−Vs) level scanning pulse is applied to the scanning electrode Y selected by the line-sequential operation, and the ground level voltage is applied to the non-selected scanning electrode.

In this process, the address electrode Aj, out of the individual address electrodes A1 to Am, corresponded to the cell to be brought into sustain discharge, that is, the cell to be illuminated, is selectively applied with an addressing pulse at voltage Va. As a consequence, electric discharge takes place between the address electrode Aj of the cell to be illuminated and the scanning electrode Y selected by the line-sequential operation, and using the discharge as a priming (ignition), the wall discharge enough for inducing the next sustain discharge is accumulated in the surficial portion of the MgO protecting film over the common electrode X and the scanning electrode Y.

Thereafter in the sustain discharge period, the common electrode X and the scanning electrode Y of the individual display lines are alternatively applied with voltages (+Vs, −Vs) differing in the polarity from each other to thereby effect sustain discharge, to thereby display video of one subfield. The operation herein alternatively applying voltages differing in the polarity is referred to as “sustain operation”, and the pulses at voltages (+Vs, −Vs) during the sustain operation are referred to as “sustain pulses”.

In the sustain discharge period, the scanning electrode Y is applied with voltage (Vs+Vx) only for the first time of high voltage application. The voltage Vx, added to the wall charge generated during the addressing period, is an additional voltage for generating voltage necessary for the sustain discharge.

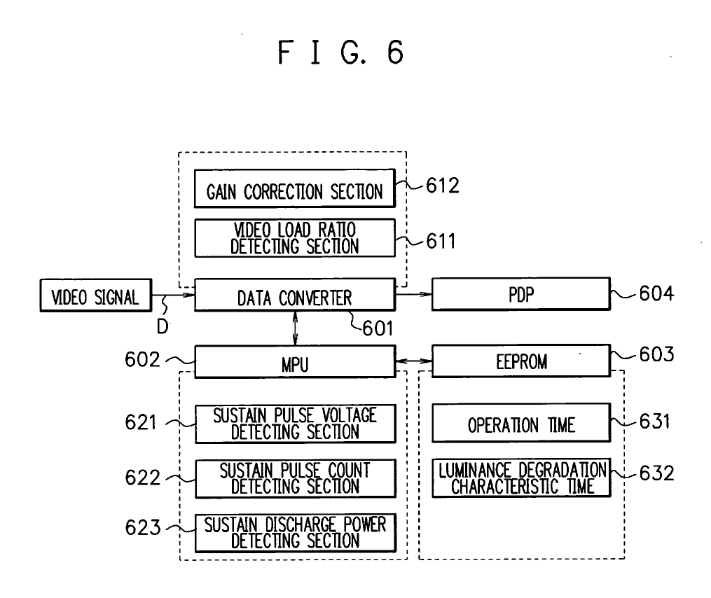

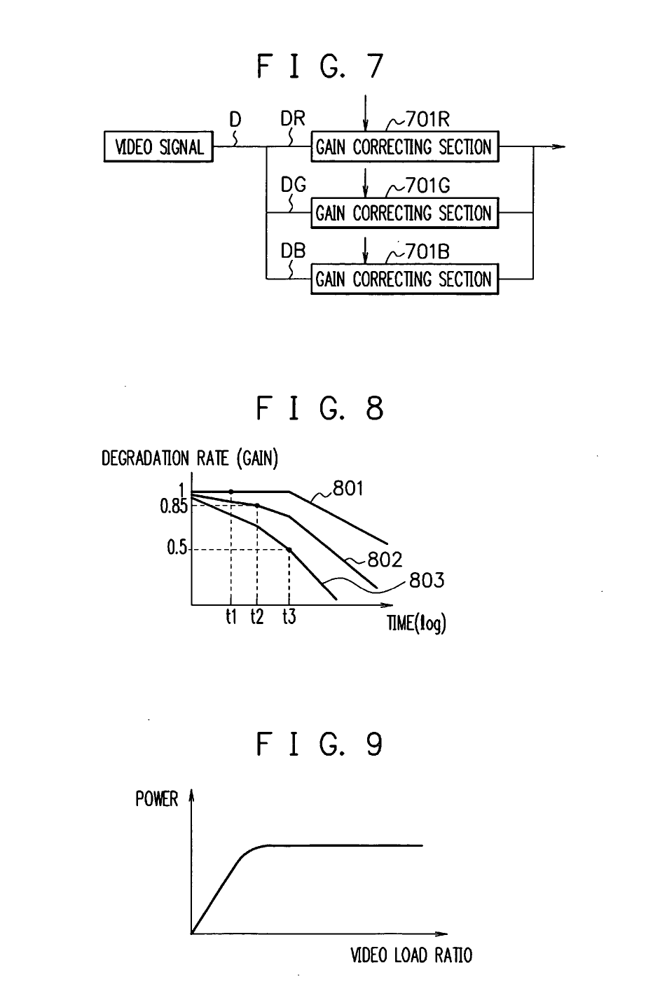

FIG. 6 is a drawing showing an exemplary configuration of the gain correction section in the display data controlling section 11 of the plasma display device shown in FIG. 1. A data converter 601 has a video load ratio detecting section 611 and a gain correction section 612, receives the video signal D, color-wisely corrects gain of the video signal D, and outputs the signal to the plasma display panel (PDP) 604. A configuration of the gain correction section 612 will be described later referring to FIG. 7. The plasma display panel 604 has the display panel 1 and the drivers 4 to 7 shown in FIG. 1, and presents display corresponding to video signals color-wisely corrected in gain by the gain correction section 612.

The video load ratio detecting section 611 detects video load ratio corresponding to the video signal D, and outputs it to a microprocessor (MPU) 602. The video load ratio is detected based on the number of illuminated pixels and gradation value of the illuminated pixels. For an exemplary case where the all pixels are displayed with a maximum gradation value, the video load ratio will have a value of 100%. For another exemplary case where all pixels are displayed with a half of the maximum gradation value, the video load ratio will have a value of 50%. For still another exemplary case where only a half (50%) of the pixels are displayed with the maximum gradation value, the video load ratio again will have a value of 50%.

The microprocessor 602 has a sustain pulse voltage detecting section 621, a sustain pulse count detecting section 622 and a sustain discharge power detecting section 623, and takes part in input/output to or from the data converter 601 and an EEPROM (non-volatile memory) 603.

The sustain pulse voltage detecting section 621 detects sustain pulse voltage Vs shown in FIG. 5. The sustain pulse voltage Vs differs for every plasma display panel 604 by variation.

The sustain pulse count detecting section 622 detects the number of sustain pulses in the sustain discharge period shown in FIG. 5. The number of sustain pulses varies depending on the power-constant control by the luminance/power controlling section 9 shown in FIG. 1.

The sustain discharge power detecting section 623 detects power under current flow through the display electrodes X1 to Xn and the scanning electrode Y1 to Yn, when electric discharge takes place by the sustain pulses in the sustain discharge period, in response to the detecting section 12 shown in FIG. 1. The sustain discharge power is obtained by detecting current flowing through the display electrodes X1 to Xn and the scanning electrode Y1 to Yn in the display panel 1.

The EEPROM 603 stores an operation time 631 and a luminance degradation characteristic time 632. The microprocessor 602 calculates the operation time 631 and the luminance degradation characteristic time 632, and records them into the EEPROM 603. The operation time is a duration of time (video display time) over which power is supplied to the plasma display device, and thereby video (including black-level display) is displayed.

The microprocessor 602 also calculates luminance degradation characteristic time (luminance degradation characteristic data) 632 based on the above-described operation time, the video load ratio, the number of sustain pulses, the sustain discharge power, and/or the sustain pulse voltage, and records it into the EEPROM 603. The microprocessor 602 also controls the gain correction by the gain correction section 612, corresponding to the luminance degradation characteristic time 632. The gain correction section 612 color-wisely corrects gain under control by the microprocessor 602. The details will be described later.

FIG. 7 is a drawing showing an exemplary configuration of the gain correction section 612 shown in FIG. 6. Video signal D has red video signal DR, green video signal DG and blue video signal DB. The gain correction section 701R corrects gain of the red video signal DR under control by the microprocessor 602. The gain correction section 701G corrects gain of the green video signal DG under control by the microprocessor 602. The gain correction section 701B corrects gain of the blue video signal DB under control by the microprocessor 602.

FIG. 8 is a graph showing exemplary relationships between time and rate of luminance degradation. The abscissa represents logarithmic expression of time, and the ordinate represents rate of luminance degradation of video signals of the individual colors. For example, a characteristic curve 801 represents a characteristic of degradation rate for red color, a characteristic curve 802 represents a characteristic of degradation rate for green color, and a characteristic curve 803 represents a characteristic of degradation rate for blue color. The graph shows rates of luminance degradation with elapse of time, assuming the rates of luminance degradation, at the initial time of zero, expressed by the characteristic curves 801 to 803 for red, green and blue as 1. The rates of degradation differ from color to color. The red characteristic curve 801 shows only a small degradation, wherein the blue characteristic curve 801 shows a large tendency of degradation. As a consequence, the white balance decays with time, and the video display adds a reddish tone.

Data of the characteristic curves 801 to 803 are typically stored in a form of table data in the microprocessor 602 shown in FIG. 6. The luminance degradation characteristic time 632 shown in FIG. 6 corresponds to time on the abscissa in FIG. 8. For an exemplary case where the luminance degradation characteristic time 632 is t3, gains of three colors of video signals DR, DG, DB are corrected so as to be suited to the one of the three, showing a smallest value of rate of luminance degradation. More specifically, the blue characteristic curve 803 shows a smallest value of rate of luminance degradation of 0.5, so that the gains of the video signals DR, DG, DB are corrected so as to adjust the rates of degradation for all colors to 0.5. Different gain corrections can be made herein color by color.

The luminance degradation characteristic time T1 can be expressed by the equation (1), where T2 is operation time measured at predetermined intervals of time, K1 is video load ratio, and Ns is the number of sustain pulses. B1 is a coefficient calculated based on conditions for determining the above-described characteristic curves, and is typically a value corresponding to the video load ratio multiplied by the number of sustain pulses, giving the characteristics shown in FIG. 8. K2 is a coefficient dependent to the sustain pulse voltage Vs. In short, the luminance degradation characteristic time Ti is determined by cumulatively summing up T2×Ns×K1/(B1×K2) with the elapse of time. It is to be noted that T2 may be time corresponded to the operation time, Ns may be a value relevant to the number of sustain pulses, and K2 may be sustain pulse voltage Vs per se.
T1=93 {T2×Ns×K1/(B1×K2)} (1)

Reasons why the individual parameters affect the luminance degradation characteristic time T1 will be explained below. First, it is obvious that the individual phosphors 38 of red, green and blue shown in FIG. 2C degrade, and that the luminance values for the individual colors degrade corresponding to the operation time T2. The operation time T2 therefore affects the luminance degradation characteristic time T1.

FIG. 9 is a graph showing an exemplary relationship between the video load ratio K1 and sustain discharge power. Assuming now that the number of sustain pulses is kept constant, the sustain discharge power increases as the video load ratio increases. In order to suppress increase in the power, the luminance/power controlling section 9 shown in FIG. 1 then controls, when the video load ratio is large, the number of sustain pulses typically so as to make the power constant. More specifically, the number of sustain pulses is reduced when the video load ratio increases. The power can consequently be kept constant when the video load ratio is large, as shown in FIG. 9.

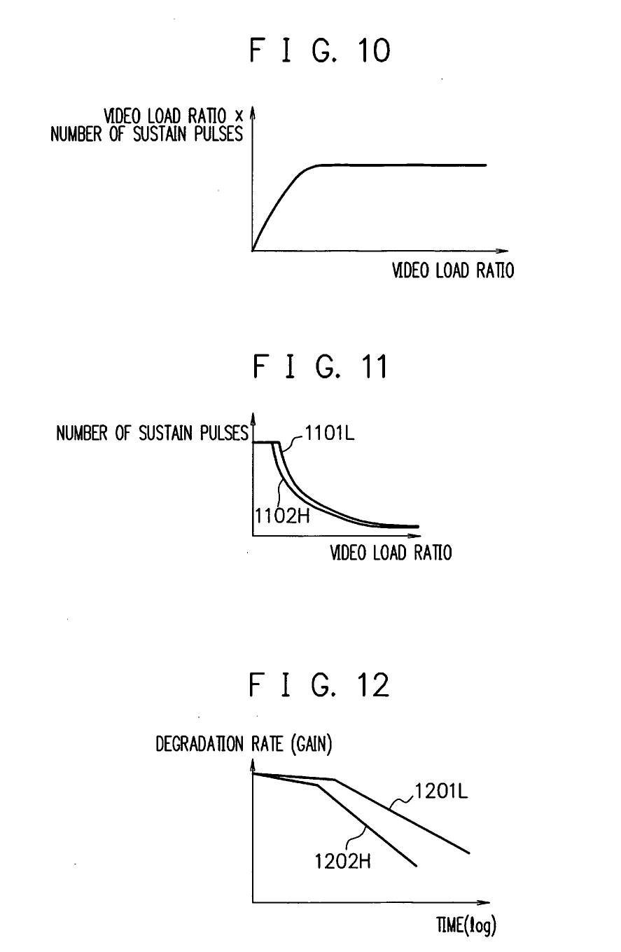

FIG. 10 is a graph showing an exemplary relationship between the above-described Ns (value relevant to the number of sustain pulses)×K1 (video load ratio) and K1 (video load ratio). As described in the above, the power-constant control reduces the number of sustain pulses Ns when the video load ratio K1 becomes large. As a consequence, increase in the video load ratio K1 allows Ns×K1 to show a constant characteristic. In other words, Ns×K1 shows a characteristic similar to the sustain discharge power shown in FIG. 9.

The larger the sustain discharge power grows, the larger the number of times of light emission by the sustain discharge becomes, so that the luminance degradation more likely to proceed. In other words, a larger Ns×K1 results in a larger tendency of luminance degradation. It is therefore understood that the luminance degradation characteristic time T1 depends on Ns×K1.

It is to be noted that the video load ratio is calculated independently for every frame. A maximum value for Ns×K1 is now assumed as 1, so as to normalize the value of Ns×K1. For an exemplary case where the display is given at a rate of one frame per one second, a value of Ns×K1 of 1 gives 1 second, and a value of Ns×K1 of 0.5 gives 0.5 seconds. The time is expressed as Ns×K1 in the equation (1) shown in the above. The time may also be expressed as Ns×K1 after being summing up over a predetermined period.

FIG. 11 is a graph showing exemplary relationships between video load ratio K1 and the number of sustain pulses Ns, under varied sustain pulse voltage values. For example, a characteristic curve 1101L represents a characteristic under a drive voltage Vs of the sustain pulse of 80 V, and a characteristic curve 1102H represents a characteristic under a drive voltage Vs of the sustain pulse of 82 V. As shown in FIG. 11, difference in set values for the drive voltage Vs results in different characteristics (plateau) shown in FIG. 10. The basic degradation characteristics of the phosphor are supposedly determined by power (voltage x current). If the set voltage should vary, the basic characteristics of the phosphor can be independent of the drive voltage Vs, if the control is made by correspondently reducing the current (the number of sustain pulses) so as to keep the drive power unchanged. The characteristics of video load ratio x the number of sustain pulses (or a value relevant to the number of sustain pulses) shown in FIG. 10 are determined by the video load ratio, irrespective of setting of the drive voltage Vs. It is therefore made possible to determine the characteristics shown in FIG. 10 independent of the drive voltage Vs, based on a table of (video load ratio) versus (the number of sustain pulses, or a value relevant to the number of sustain pulses) obtained for a reference panel, or an operation expression.

FIG. 12 is a graph showing exemplary relationships between time and the rate of luminance degradation, under varied sustain pulse voltage values. The time is given as a logarithmic expression on the abscissa. For example, a characteristic curve 1201L represents a characteristic under a sustain pulse voltage Vs of 80 V, and a characteristic curve 1202H represents a characteristic under a sustain pulse voltage Vs of 82 V. Because high sustain pulse voltage Vs induces strong sustain discharge, some phosphor may show different luminance degradation characteristics depending on the voltage even under application of the same power. High voltage also increases the reactive current (charging power) and correspondently reduces the discharge power. Taking such characteristics into account, a solution now is to adopt a coefficient K2 dependent to the sustain pulse voltage Vs. A more accurate gain correction against the luminance degradation is thus provided.

It is to be noted now that the coefficient K2 dependent to the sustain pulse voltage Vs is omissible from the equation (1) in the above. In this case, the luminance degradation characteristic time T1 can be expressed by the equation (2) below:
T1=Σ(T2×Ns×K1/B1) (2)

Also as described in the above, in the equations (1) and (2) in the above, Ns×K1 can be replaced by the sustain discharge power P1 shown in FIG. 9. In this case, the luminance degradation characteristic time T1 can be expressed by the equations (3) and (4) below:
T1=93 {T2×1/(B1×K2)} (3)
T1=93 (T2×P1/B1) (4)

The video load ratio K1 may be calculated one-by-one for every frame, or may be calculated color-by-color within one frame. In this case, video load ratio K1 for red, video load ratio K1 for green, and video load ratio K1 for blue are obtained. As a consequence, luminance degradation characteristic time T1 for red, luminance degradation characteristic time T1 for green, and luminance degradation characteristic time T1 for blue are obtained. Assuming now, for example in FIG. 8, that the luminance degradation characteristic time T1 for red is t1, the luminance degradation characteristic time T1 for green is t2, and the luminance degradation characteristic time T1 for blue is t3, luminance degradation for red is read as approximately 1, luminance degradation for green as approximately 0.85, and luminance degradation for blue as approximately 0.5. In this case, as has been described in the above, the gains are corrected so as to be suited to a luminance degradation value of 0.5, the smallest of all. The gain correction section 701R for red shown in FIG. 7 corrects the gain from 1 to 0.5 for correcting the luminance degradation. The gain correction section 701G for green corrects the gain to 0.5/0.85=0.59. The gain correction section 701B for blue is in no need of gain correction, and allowed to output the input video signal DB without modification.

As has been described in the above, this embodiment can calculate the luminance degradation characteristic time (luminance degradation characteristic data) T1 based on the above-described operation time T2, the video load ratio K1, the number of sustain pulses Ns, the sustain discharge power P1, and/or the coefficient K2 dependent to the sustain pulse voltage Vs, and can color-wisely correct the gains of the video signals. It is therefore made possible to more exactly correct luminance degradation in a color-wise manner, and to prevent degradation of image quality while keeping the white balance unchanged.

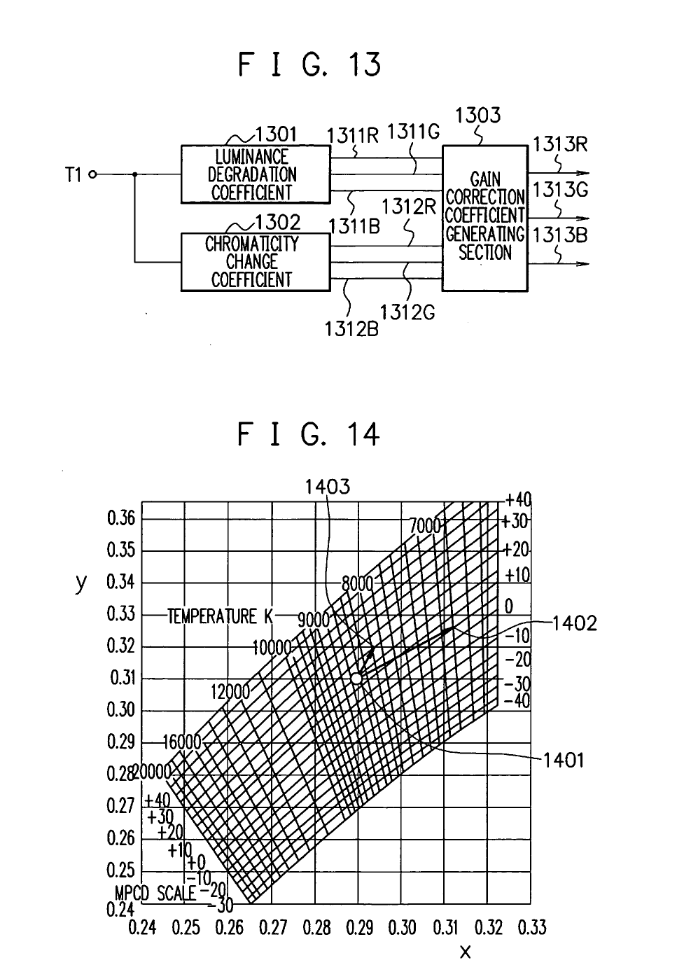

FIG. 13 is a drawing showing an exemplary configuration of a circuit generating gain correction coefficients based on luminance degradation coefficients and chromaticity change coefficients. Time T1 corresponds to the above-described luminance degradation characteristic time T1. A luminance degradation coefficient table 1301 is a look-up table storing correlations between time T1 and the luminance degradation coefficients (gain correction coefficients) of the phosphor 38 (plasma display panel 604). In the above embodiment, the luminance degradation coefficient table 1301 outputs, based on time T1, a gain correction coefficient 1311R for red, a gain correction coefficient 1311G for green, and a gain correction coefficient 1311B for blue respectively to the gain correction sections 701R, 701G and 701B shown in FIG. 7. The gain correction sections 701R, 701G and 701B respectively correct gains of the video signals DR, DG and DB, respectively based on the gain correction coefficients 1311R, 1311G and 1311B.

In FIG. 13 has, besides the luminance degradation coefficient table 1301, provided therein a chromaticity change coefficient table 1302 and a gain correction coefficient generating section 1303. The chromaticity change coefficient table 1302 is a look-up table storing correlations between time T1 and chromaticity change coefficient (gain correction coefficient) of the phosphor 38 (plasma display panel 604). The luminance degradation coefficient table 1301 outputs, based on time T1, the luminance degradation coefficient (gain correction coefficient) 1311R for red, the luminance degradation coefficient (gain correction coefficient) 1311G for green, and the luminance degradation coefficient (gain correction coefficient) 1311B for blue. The luminance degradation coefficients 1311R, 1311G and 1311B are gain correction coefficients correcting luminance degradation of the phosphor 38 with elapse of time shown in the above-described embodiment. The chromaticity change coefficient table 1302 outputs, based on time T1, a chromaticity change coefficient (gain correction coefficient) 1312R for red, a chromaticity change coefficient (gain correction coefficient) 1312G for green, and a chromaticity change coefficient (gain correction coefficient) 1312B for blue. The chromaticity change coefficients 1312R, 1312G and 1312B are gain correction coefficients correcting changes in chromaticity of the phosphor 38 of each color with elapse of time, detailed later. The gain correction coefficient generating portion 1303 generates a gain correction coefficient 1313R for red, a gain correction coefficient 1313G for green, and a gain correction coefficient 1313B for blue, based on the luminance degradation coefficient 1311R for red, the luminance degradation coefficient 1311G for green, the luminance degradation coefficient 1311B for blue, the chromaticity change coefficient 1312R for red, the chromaticity change coefficient 1312G for green, and the chromaticity change coefficient 1312B for blue, and outputs them respectively to the gain correction sections 701R, 701G and 701B shown in FIG. 7. The gain correction sections 701R, 701G and 701B respectively correct gains of the video signals DR, DG and DB, respectively based on the gain correction coefficients 1313R, 1313G and 1313B.

FIG. 14 is a drawing showing chromaticity. The abscissa represents the x axis of the chromaticity, and the ordinate represents the y axis of the chromaticity. For example, a chromaticity at around x=0.29 and y=0.31 indicates white, increase in y shifts the chromaticity to green, increase in x shifts it to red, and decrease in x and y shifts it to blue. A coordinate point 1401 represents, for example, a chromaticity point of white of the phosphor 38 in the initial stage at a time T1 of 0. The chromaticity point 1401 undesirably shifts with elapse of time. A coordinate point 1402 represents a chromaticity point of white, after time T1 reaches 60 thousand hours, and after the gain was corrected using only luminance degradation coefficient 1311R, 1311G and 1311B, but without using the chromaticity change coefficients 1312R, 1312G and 1312B. The phosphors 38 of red, green and blue change not only in the luminance, but also in the chromaticity, and this results in shifting of the chromaticity such as towards the chromaticity point 1402, even if the rate of luminance degradation is corrected. By adjusting the gain correction coefficients for red, green and blue, taking also such shifting in the chromaticity into consideration, it is made possible to leave the chromaticity unshifted, or to shift the chromaticity to an arbitrary direction. For example, by correcting the gain so as to leave the chromaticity unshifted, using the chromaticity change coefficients 1312R, 1312G and 1312B, the chromaticity point 1402 can be brought back to the initial chromaticity point 1401. The chromaticity point 1402 can also be shifted to an arbitrary direction, by correcting the gain so as to shift the chromaticity to an arbitrary direction using the chromaticity change coefficients 1312R, 1312G and 1312B.

The gain correction coefficient generating section 1303 can bring the chromaticity point, which has shifted with elapse of time, back to the chromaticity point 1401, or can shift it to a desired chromaticity point 1403, after time T1 reached 60 thousand hours, by generating the gain correction coefficients 1313R, 1313G and 1313B, based on the luminance degradation coefficients 1311R, 1311G, 1311B and the chromaticity change coefficients 1312R, 1312G, 1312B.

The gain correction using only the luminance degradation coefficients 1311R, 1311G and 1311B is successful in obtaining a large effect. Changes in the chromaticity by such correction are relatively small. The chromaticity change coefficients 1312R, 1312G and 1312B are used to further correct such small changes in the chromaticity. The gain correction using the luminance degradation coefficients 1311R, 1311G and 1311B, in combination with the chromaticity change coefficients 1312R, 1312G and 1312B allows more accurate gain correction.

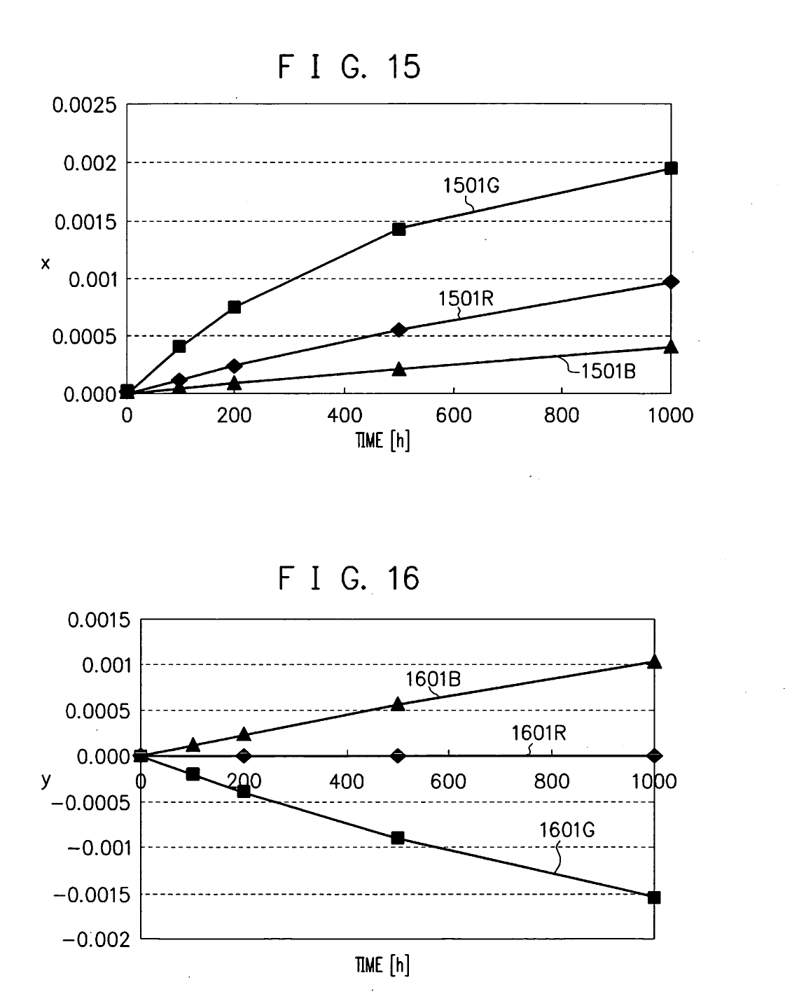

FIG. 15 is a graph showing exemplary relationships between time T1 and x value of the chromaticity. The abscissa represents time T1 [hour] and the ordinate represents relative x value of the chromaticity. Change characteristic 1501R expresses changes in the x value of chromaticity for red with respect to time T1. Change characteristics 1501G expresses changes in the x value of chromaticity for green with respect to time T1. Change characteristics 1501B expresses changes in the x value of chromaticity for blue with respect to time T1.

FIG. 16 is a graph showing exemplary relationships between time T1 and y value of chromaticity. The abscissa represents time T1 [hour] and the ordinate represents relative y value of the chromaticity. Change characteristic 1601R expresses changes in the y value of chromaticity for red with respect to time T1. Change characteristics 1601G expresses changes in the y value of chromaticity for green with respect to time T1. Change characteristics 1601B expresses changes in the y value of chromaticity for blue with respect to time T1.

The chromaticity change coefficient table 1302 typically outputs the chromaticity change coefficients 1312R, 1312G and 1312B correcting changes in the x value and the y value of the chromaticity shown in FIG. 15 and FIG. 16.

As has been described in the above, luminance degradation of the phosphors of the individual colors and changes in chromaticity of the phosphors of the individual colors, with elapse of time, can be corrected by generating the gain correction coefficients 1313R, 1313G and 1313B, based on the luminance degradation coefficients 1311R, 1311G, 1311B and the chromaticity change coefficients 1312R, 1312G, 1312B.

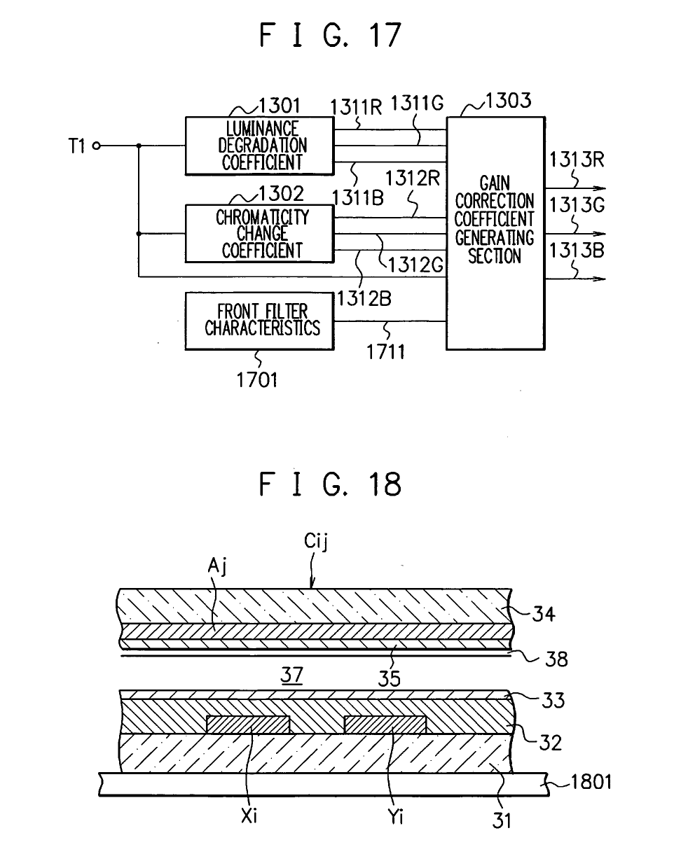

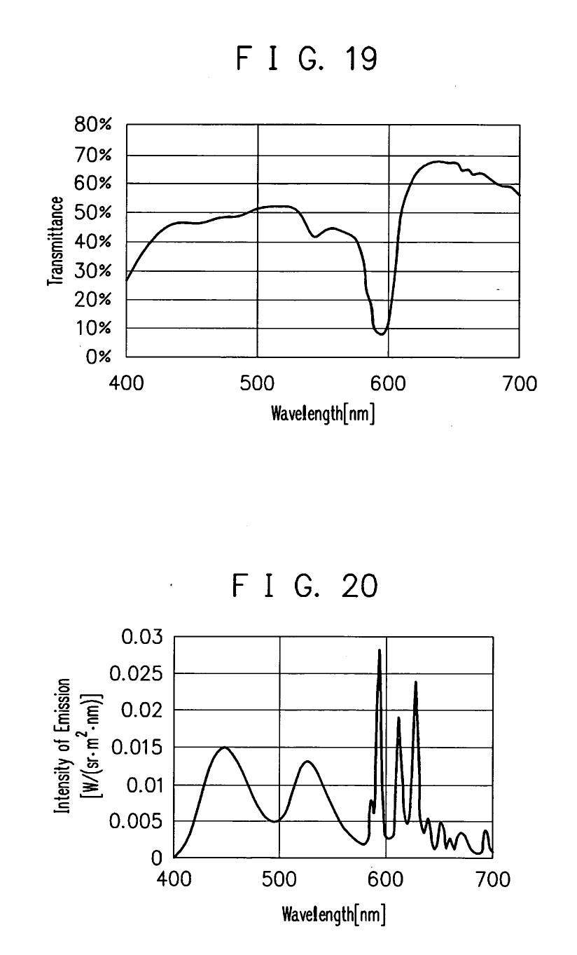

FIG. 17 is a drawing showing an exemplary configuration of a circuit generating gain correction coefficients based on luminance degradation coefficients, chromaticity change coefficients and front filter characteristics, corresponding to FIG. 13 added with a front filter characteristic table 1701. The front filter characteristics table 1701 is a table storing the front filter characteristics (FIG. 19) described later, and outputs a front filter characteristic 1711. The gain correction coefficient generating section 1303 generates the gain correction coefficient 1313R for red, the gain correction coefficient 1313G for green and the gain correction coefficient 1313B for blue, based on the luminance degradation coefficients 1311R, 1311G, 1311B, chromaticity change coefficients 1312R, 1312G, 1312B, time T1 and the front filter characteristic 1711, and outputs them respectively to the gain correction sections 701R, 701G and 701B shown in FIG. 7. The gain correction sections 701R, 701G and 701B correct gains of the video signals the DR, DG and DB based on the gain correction coefficients 1313R, 1313G and 1313B, respectively.

FIG. 18 is a drawing showing an exemplary configuration shown by the sectional drawing in FIG. 2A added with a front filter 1801. The front filter 1801 may be provided so as to contact with the front glass substrate 31, or may be apart therefrom. The front filter 1801 is provided for shielding from any unnecessary electromagnetic wave. The front filter 1801 is provided on the front surface of the plasma display panel 604.

FIG. 19 is a graph showing an exemplary characteristic of the front filter. The abscissa represents wavelength [nm], and the ordinate represents transmittance. The front filter 1801 typically has a characteristic of intercepting light at around 600 nm.

FIG. 20 is a graph showing an exemplary emission intensity of the plasma display panel 604. The abscissa represents wavelength [nm], and the ordinate represents intensity of emission of the plasma display panel 604. The plasma display panel 604 involves neon emission based on neon (Ne) discharge, in addition to light emission from the phosphor 38. The neon emission occurs typically at around a wavelength of 600 nm. By using the front filter 1801 having the characteristic shown in FIG. 19, it is made possible to control, for example, transmission characteristics adaptive to the individual colors, and interception ratio of wavelength of neon emission.

Under varied transmission ratio of neon emission, it is supposed that degree of expression of the chromaticity of a single color may considerably vary depending on presence or absence of the front filter 1801. This case needs gain correction using the front filter characteristics table 1701. In emission intensity characteristics shown in FIG. 20, emission wavelength of the phosphor 38 may slightly shift with elapse of time. Shift in the wavelength results in different transmittance values, as being contributed by the front filter characteristics shown in FIG. 19. It is therefore necessary to generate the gain correction coefficients for the individual colors, taking the transmittance values into consideration.

The front filter characteristics table 1701 stores the front filter characteristics shown in FIG. 19, and outputs the front filter characteristics 1711. The gain correction coefficient generating section 1303 generates gain correction coefficients 1313R, 1313G and 1313B, based on time T1 and the front filter characteristics 1711.

As has been described in the above, the gain correction using the front filter characteristics table 1701 is not necessary for the case without front filter 1801, whereas for the case with the front filter 1801, more accurate gain correction can be realized by using the front filter characteristics table 1701.

The present embodiments makes it possible to exactly correct luminance degradation in a color-wise manner, consequently to sustain a good white balance, and to prevent degradation in image quality.

It is to be understood herein that the above-described embodiments are merely for the purpose of showing specific examples of embodiment of the present invention, by which the technical scope of the present invention should not be limitedly interpreted. In other words, the present invention can be embodied in various modified forms, without departing from the technical spirit and essential features thereof.

What is claimed is:

1. A plasma display device comprising:
a gain correction section color-wisely correcting gains of video signals for a plurality of colors; and
a plasma display panel presenting display corresponding to said gain-corrected video signals while being supplied with sustain pulses,
wherein said gain correction section color-wisely corrects gains of said video signals, corresponding to time corresponded to the operation time, video load ratio, and the number of said sustain pulses or values relevant thereto.

2. The plasma display device according to claim 1, wherein said gain correction section color-wisely corrects gains of said video signals, corresponding to video load ratios for the individual colors.

3. The plasma display device according to claim 1, wherein said gain correction section color-wisely corrects gains of said video signals, corresponding to voltage levels of said sustain pulses or coefficients dependent thereto.

4. The plasma display device according to claim 1, wherein said plurality of colors are three colors of red, green and blue, and
said gain correction section corrects gains of said video signals respectively for red, green and blue colors.

5. The plasma display device according to claim 1, wherein said gain correction section carries out gain correction different by colors.

6. The plasma display device according to claim 1, wherein said gain correction section color-wisely corrects gains of said video signals, corresponding to luminance degradation coefficients of said plasma display panel and chromaticity change coefficients of said plasma display panel.

7. The plasma display device according to claim 1, wherein said gain correction section color-wisely corrects gains of said video signals, corresponding to luminance degradation coefficients of said plasma display panel, chromaticity change coefficients of said plasma display panel, and characteristics of a front filter provided in front of said plasma display panel.

8. A plasma display device comprising:
a gain correction section color-wisely correcting gains of video signals for a plurality of colors; and
a plasma display panel presenting display based on electric discharge, corresponding to said gain-corrected video signals while being supplied with sustain pulses,
wherein said gain correction section color-wisely corrects gains of said video signals,
corresponding to time corresponded to the operation time, video load ratio, and power of said electric discharge.

9. The plasma display device according to claim 8, wherein said gain correction section color-wisely corrects gains of said video signals, corresponding to voltage levels of said sustain pulses or coefficients dependent thereto.

10. A method of treating a plasma display device which comprises a gain correction section color-wisely correcting gains of video signals for a plurality of colors; and a plasma display panel presenting display corresponding to said gain-corrected video signals while being supplied with sustain pulses, said method comprising:
a gain correction step color-wisely correcting gains of said video signals, corresponding to the time corresponded to the operation time, video load ratio, and the number of said sustain pulses or values relevant thereto; and
a display step presenting display corresponding to said gain-corrected video signals.

11. The method of treating a plasma display device according to claim 10, wherein said gain correction step color-wisely corrects gains of said video signals, corresponding to video load ratios for the individual colors.

12. The method of treating a plasma display device according to claim 10, wherein said gain correction step color-wisely corrects gains of said video signals, corresponding to voltage levels of said sustain pulses or coefficients dependent thereto.

13. The method of treating a plasma display device according to claim 10, wherein said plurality of colors are three colors of red, green and blue, and
said gain correction step corrects gains of said video signals respectively for red, green and blue colors.

14. The method of treating a plasma display device according to claim 10, wherein said gain correction step carries out gain correction different by colors.

15. The method of treating a plasma display device according to claim 10, wherein said gain correction step color-wisely corrects gains of said video signals, corresponding to luminance degradation coefficients of said plasma display panel and chromaticity change coefficients of said plasma display panel.

16. The method of treating a plasma display device according to claim 10, wherein said gain correction step color-wisely corrects gains of said video signals, corresponding to luminance degradation coefficients of said plasma display panel, chromaticity change coefficients of said plasma display panel, and characteristics of a front filter provided in front of said plasma display panel.

17. A method of treating a plasma display device which comprises a gain correction section color-wisely correcting gains of video signals for a plurality of colors; and a plasma display panel presenting display based on electric discharge, corresponding to said gain-corrected video signals while being supplied with sustain pulses, said method comprising:
a gain correction step color-wisely correcting gains of said video signals, corresponding to time corresponded to the operation time, video load ratio, and power of said electric discharge; and
a display step presenting display corresponding to said gain-corrected video signals.

18. The method of treating a plasma display device according to claim 17, wherein said gain correction step color-wisely corrects gains of said video signals, corresponding to voltage levels of said sustain pulses or coefficients dependent thereto.
